(19) United States
(12) Patent Application Publication
(10) Pub. No.: US 2025/0193765 A1
(43) Pub. Date: Jun. 12, 2025

(54) METHOD FOR SELECTING A COMMUNICATION PATH TO BE USED BETWEEN AN OFFSHORE VEHICLE AND AN ONSHORE OPERATION CENTRE

(71) Applicant: FNV IP B.V., Leidschendam (NL)

(72) Inventors: John Darius ROBIDEAUX, Lafayette, LA (US); Michael Joseph BLANCHARD, Lafayette, LA (US); Christopher Ray STELLY, Lafayette, LA (US); Edwin Martin HOWARD, Lafayette, LA (US)

(21) Appl. No.: 18/536,203

(22) Filed: Dec. 11, 2023

(51) Int. Cl. H04W 40/02; G07C 5/00; H04B 7/185; H04L 45/24

(52) U.S. Cl. CPC H04W 40/02; G07C 5/008; H04B 7/18528; H04L 45/24

(57) ABSTRACT

A method for selecting a communication path to be used between an offshore vehicle and an onshore data infrastructure. Multiple communication paths employing different communication technologies are available between the offshore vehicle and the onshore data infrastructure. The method is performed by a processor and comprises the steps of: determining an operational mode of the offshore vehicle; determining a purpose, among a plurality of defined purposes, of data traffic to be transmitted between the offshore vehicle and the onshore data infrastructure, the purpose being associated with transmission urgencies of different data traffic; selecting a communication path for the data traffic based on a mapping policy designed for the operational mode of the offshore vehicle; wherein different mapping policies are designed for different operational modes of the offshore vehicle, each mapping policy comprises a group of rules each associating a purpose of data traffic with one or more communication paths and a priority level of the one or more communication paths. Unlocking insights from Geo-Data, the present invention further relates to improvements in sustainability and environmental developments: together we create a safe and liveable world.

### FIELD OF THE INVENTION

The present disclosure generally relates to the field of data communication, and more specifically to a method and device for selecting a communication path to be used between an offshore vehicle and an onshore operation centre. Unlocking insights from Geo-Data, the present invention further relates to improvements in sustainability and environmental developments: together we create a safe and liveable world.

### BACKGROUND OF THE INVENTION

Communication and data transfer between remote assets, such as offshore vehicles or sensors deployed or provided on the offshore vehicles, and local onshore operation centres are critical for various industries, including offshore oil and gas, maritime shipping, environmental monitoring, and so on. This communication allows for real-time monitoring, control, and data collection from remote locations.

Remote assets can include offshore vessels, autonomous underwater vehicles, AUVs, remotely operated vehicles, ROVs, sensors, and other equipment deployed in offshore or remote locations. These assets are equipped with various sensors, cameras, and instruments to collect data and perform specific tasks.

The remote assets collect data relevant to their mission or operation. This data can include environmental data, e.g., sea temperature, pressure, and salinity, equipment status, video feeds, and other relevant information.

To transmit data from the remote assets to an onshore operation centre, various communication technologies are employed. For example, Satellite Communication employing Geostationary or low Earth orbit, LEO, satellites are used to establish a connection between the remote assets and onshore centres. This is especially useful for offshore locations where terrestrial networks are unavailable. As an alternative, radio frequencies are utilized for short-range communication between assets and nearby relay points or vessels. If available in the area, cellular networks may be used for data transfer, especially when assets are closer to shore.

As can be contemplated by those skilled in the art, connectivity between remote assets and local operation centres can be intermittent and reliability is often variable. In the meantime, critical data, i.e., data that needs to be transfer with little latency, competes with non-critical data which can be delayed in transferring for bandwidth.

Given the challenges of offshore and remote environments, ensuring reliable data transmission is crucial. Redundant communication paths, error correction, and data retransmission mechanisms are often used to mitigate the impact of unreliable connections.

Following a known approach, additional network providers or bearers to the remote side are provided. Usually, Very Small Aperture Terminals, VSAT, and 4G LTE communication are employed. This allows for multiple paths back to the local operating centres. In this case, a hardware, that is, a terminal device, will automatically switch all traffic from one provider to another, based on a variety of variables including for example cost or quality considerations. The switching may also be performed manually.

Having multiple routes available for data to travel from a remote site to an operation centre provides a level of redundancy which can ensure a mostly uninterrupted flow of data. However, this routing applies to all traffic leaving the remote site. Whether a person manually switches from using VSAT to 4G LTE, or the hardware itself makes the switch, all data is now using the new route. If multiple paths are viable, there is no easy way to send certain traffic over all available paths simultaneously, while directing other data to an alternative path.

Furthermore, there is a performance/reliability “hit” when making this switch, especially if done manually; data flow will be interrupted for some amount of time. This could happen at “critical moments of operations” and have negative consequences.

In an alternative approach, traffic is categorized into specific priorities, so that “important” data is prioritized over less important data. As an example, all voice traffic is prioritized over email data.

Categorizing data and granting these categories a “policy” allows a router to prioritize certain traffic over others. This is useful, for example, to prioritize “mission critical” data, such ROV activities, or other live operational data, over less critical data including background file transfers, or software updates. However, these policies are typically fixed, or static, in nature. File transfer data will always have a low priority, even if there are no mission critical operations occurring at the time. Such an approach therefore cannot accommodate varying situations which may relate to varying priorities of different traffic. There is no easy way to take advantage of the operational “down time”, and increase the priority of software updates, for example.

In consideration of the above it is desirable there is a method of selecting a communication path to be used between an offshore vehicle and an onshore operation centre that allows the communication path to be adapted based on varying conditions associated with different traffic.

### BRIEF SUMMARY OF THE INVENTION

According to one aspect of the present disclosure, there is presented method for selecting a communication path to be used between an offshore vehicle and an onshore data infrastructure, multiple communication paths employing different communication technologies being available between the offshore vehicle and the onshore data infrastructure, the method performed by a processor and comprising the steps of:
determining an operational mode of the offshore vehicle;
determining a purpose, among a plurality of defined purposes, of data traffic to be transmitted between the offshore vehicle and the onshore data infrastructure, the purpose being associated with transmission urgencies of different data traffic;
selecting a communication path for the data traffic based on a mapping policy designed for the operational mode of the offshore vehicle;
wherein different mapping policies are designed for different operational modes of the offshore vehicle, each mapping policy comprises a group of rules each associating a purpose of data traffic with one or more communication paths and a priority level of the one or more communication paths.

The present disclosure is based on the insight that a plurality of mapping policies respectively for mapping different traffic to one or more appropriate transmission or communication path, between an offshore vehicle and an onshore operation centre, can be defined based on different operational modes of the offshore vehicle. This will allow data transmission between the offshore vehicle and the onshore data infrastructure such as an operation centre to be performed in a flexible way that not only ensures that traffic requiring less latency is delivered in time but also helps to allocate the communication resources depending on the status of the offshore vehicle.

As can be contemplated by those skilled in the art, the communication environment in offshore settings poses different and greater challenges compared to terrestrial environments. This is due to various factors such as longer communication distances, harsh weather conditions and so on. Moreover, for its safe and effective operation, the offshore vehicle often has to adapt its operation in response to the dynamic conditions. Adapting the communication paths for different traffic not only based on transmission urgencies of the traffic but also based on operational modes of the offshore vehicle therefore allows flexible and improved communication resource allocation.

Though the method above determining the purpose of data and selecting the communication path as two separate steps, in practice, as can be contemplated by those skilled in the art, once the operational mode of the vehicle is determined, the mappings (of purposes to routes) is looked up and appropriate route(s), if any, of applied to data of each purpose in the mapping.

In an example of the present disclosure, the operational mode of the offshore vehicle is determined based on information received from the offshore vehicle.

It can be contemplated by those skilled in the art that the operational mode of the offshore vehicle can be determined remotely, at the operation centre for example, based on the information that is collected from the offshore vehicle.

As an example, an operator coordinating a project involving the offshore vehicle can empirically decide what the offshore vehicle is doing, such as, on its way to the location to work, working/performing the job, is it idle due to for example bad weather conditions.

Alternatively, the operational mode of the offshore vehicle may also be determined by an algorithm, based on the information received from the vehicle.

In an example of the present disclosure, the information received from the offshore vehicle comprises one or more of telemetry data, measurement data, a state report, an alarm message, data log and so on.

As can be understood by those skilled in the art, the operational mode of the offshore vehicle can be decided based on the data collected by the offshore vehicles or other data such as a report or alarm message. This allows data transmission between the offshore vehicle and the onshore operation centre to be optimized by adapting the transmission paths for different data.

In an example of the present disclosure, determining an operational mode of the offshore vehicle comprises determining that the operational mode of the offshore vehicle remains unchanged or is different than a previously determined operational mode of the same offshore vehicle was determined.

A communication path for data of a certain purpose may be selected even if the operational mode of the offshore vehicle remains the same as previously. This allows usage of the communication resources to be optimized where necessary.

In an example of the present disclosure, the purpose of the data traffic is determined based on registration information, of an application supplying the data traffic, specified by a user.

It is known that the transmission urgencies of different data traffic may be determined based on default rules or settings, such as a voice call is always assigned a higher priority than an email message. The present disclosure defines the purpose of each data traffic based on registration information specified by a user, which can be for example an operator onboards the offshore vehicle or a surface vehicle connected to the offshore vehicle. This allows more flexibility, as it enables priority or transmission urgencies of data traffic to be adapted based on a real-time requirement.

As can be contemplated by those skilled in the art, the purposes of data may also specified by the application that the offshore vehicle registers for its service as well.

In an example of the present disclosure, multiple registration information is made by a single application.

This allows different data to be associated with different purposes. As a result, the most appropriate transmission path can be assigned for different data traffic at any specific time of the operation of the offshore vehicle.

In an example of the present disclosure, the defined purposes comprise command and control, navigation, diagnostic data, and file transfer.

For an offshore project such purposes are the most used. It will be understood by those skilled in the art the list is not exhaustive and can be adapted based on such as different projects.

In an example of the present disclosure, the selection step comprises selecting more than one communication paths for the data traffic, the more than one communication paths are based on different communication technologies and have different priority levels for the data traffic.

This helps to ensure reliability of the data transmission. In case a communication path fails due to a technical problem for example, an alternative transmission route may be used. No interruption will occur, therefore helping to maintain smooth data transmission.

In an example of the present disclosure, wherein the mapping policies are amended per request by a user.

As can be contemplated by those skilled in the art, the mapping policies may also be changed or amended based on the request from the user. This allows the optimal connectivity option and resiliency to be realised.

In an example of the present disclosure, the communication technologies comprise satellite communication, Very Small Aperture Terminals, long-range wireless communication.

The technologies are described for exemplary purpose only, any suitable communication technologies may be used based on the inventive idea of the present disclosure. It will be understood by those skilled in the art that the long-range wireless communication comprises 4G and 5G wireless communication.

In a second aspect of the present disclosure, there is presented a device for selecting a communication path to be used between an offshore vehicle and an onshore data infrastructure, multiple communication paths employing different communication technologies being available between the offshore vehicle and the onshore data infrastructure, the device comprising a processor for performing the method according to the first aspect of the disclosure.

In a third aspect of the present disclosure, there is presented method of transmitting data traffic between an offshore vehicle and an onshore data infrastructure, multiple communication paths employing different communication technologies being available between the offshore vehicle and the onshore data infrastructure, the method performed by a processor and comprising the steps of:
selecting a communication path using the method according to the first aspect of the present disclosure; and
transmitting the data traffic over the selected communication path.

In an example of the present disclosure, the data traffic is transmitted according to Data Distribution Service, DDS, protocol.

More generally, in a fourth aspect of the present disclosure, there is presented a method of routing data traffic between an offshore vehicle and a remote data infrastructure, the offshore vehicle configured to operate under multiple operational modes, the method is performed by a processor and comprises the steps of:
determining an operational mode of the offshore vehicle;
determining a purpose, among a plurality of defined purposes, of a group of data traffic to be transmitted between the offshore vehicle and the remote data infrastructure, the purposes being associated with transmission urgencies of different data traffic;
selecting, based on the determined purpose, one or more mapping rules from a routing policy designed for the determined operational mode of the offshore vehicle;
routing the group of data traffic between the offshore vehicle and the remote data infrastructure according to the one or more selected mapping rules;
wherein different routing policies are designed for different operational modes of the offshore vehicle, each routing policy comprises one or more mapping rules, each mapping rule associating a purpose of data traffic with one or more communication paths between the offshore vehicle and the onshore destination and a priority level of the one or more communication paths.

The method can be used generally for various scenarios with one or more remote data infrastructure located on the land. When more than one remote data infrastructures are involved, the communication technologies used between the remote data infrastructures and the offshore vehicle can be the same as or different from each other.

By designing different routing policies respectively for different operational modes of the offshore vehicle, the traffic can be routed between the offshore vehicle and the remote data infrastructure(s) in a priority-based manner, with redundancy where necessary, and by using different communication paths based on different communication technologies at the same time. This allows a solution providing the best connectivity option with redundancy and resiliency to be realised.

In a fifth aspect of the present disclosure, there is presented a computer program product comprising a computer readable storage medium storing instructions which, when executed on at least one processor, cause the at least one processor to carry out the method according to the first aspect of the present disclosure or the fourth aspect of the present disclosure.

The above mentioned and other features and advantages of the disclosure will be best understood from the following description referring to the attached drawings. In the drawings, like reference numerals donate identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates a communication system involving communication between an offshore vehicle and a land-based operation centre, in accordance with an embodiment of the present disclosure.

FIG. 2 schematically illustrates, in a flow chart type diagram, an embodiment of a method for selecting a communication path to be used between an offshore vehicle and an onshore operation centre.

FIG. 3 schematically illustrate an example 30 of implementing the method of the present disclosure based on the DDS protocol.

FIG. 4 schematically illustrates how the method of the present disclosure can be applied to different scenarios involving one or more remote data infrastructures communicating with the offshore vehicle based on a single or different communication technologies.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to covey the scope of the subject matter to those skilled in the art.

In the following description, the terms “data”, “traffic”, “data traffic” are used interchangeably. Moreover, the terms “remote asset”, “offshore vehicle”, “offshore device” and “offshore vessel” are also used interchangeably.

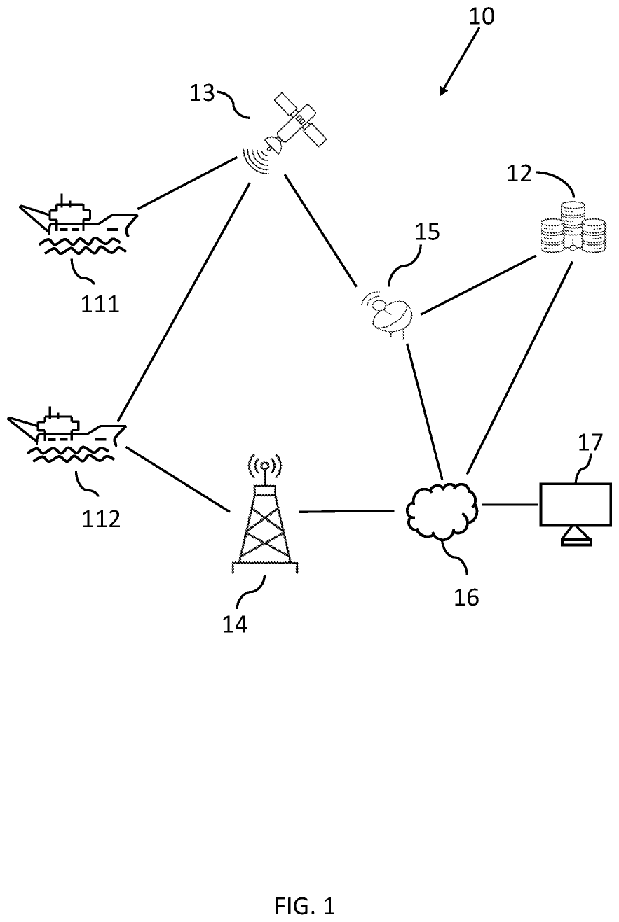

FIG. 1 schematically illustrates a communication system 10 involving communication between an offshore vehicle 111, 112 and a remote data infrastructure such as a land-based operation centre 12, in accordance with an embodiment of the present disclosure.

The offshore vehicle 111, 112 is illustrated as a surface vessel. However, it can be any offshore vehicle or device that can communicate with land operation centres, including for example, an Autonomous Underwater Vehicle, AUV, a Remotely Operated Vehicle, ROV, a buoy, a floating platform, a seafloor equipment, a drifting sensor and so on.

Take a surface vessel 111, 112 as an example, it can communicate with land operation centres using a variety of communication technologies, including satellite communication via a satellite 13, cellular or mobile communication via a cellular network 14, radio communication (not shown), and so on. A surface vessel often serves as a mobile platform for deploying and controlling other devices like AUVs or ROVs.

As can be understood by those skilled in the art, for satellite communicate, the data form the offshore vehicle 111, 112 is communicated via the satellite 13 to an earth station 15, before it reaches the operation centre 12. As for cellular communication, data transmitted over the cellular network 14 may reach the cloud 16 and then get transmitted to the operation centre 12 from the cloud.

The earth station 15 or another device 17 deployed on the land may also reach the cloud 16 via the internet and consume or use the data where needed.

Other offshore devices, such as AUVs, can be equipped with communication systems that allow them to transmit data and receive instructions from a land-based operation centre, which will not be elaborated in this disclosure.

The method of the present disclosure can be implemented as a service running on a server or a computing device located in the land-based data infrastructure. In this sense, the method is performed by a processor integrated into or coupled or connected to the computing device deployed in an operation centre or based on the cloud.

As a preparation step, software modules or applications running on a remote vehicle for managing data collected directly or indirectly by the remote vehicle can register with the service and specify categories, or “Purpose”, for their data. As an example, for an offshore vehicle involved in marine missions, some exemplary Purposes might be “Navigation Data”, “Diagnostic”, “Command & Control”, or “File Transfer”, and so on.

It will be understood by those skilled in the art that the purposes of the data may be defined or specified depending on the projects or applications generating the data to be transferred.

Moreover, a single application can make multiple registrations if it has data of differing purposes. As an example, an AUV equipped with various sensors for a certain underwater task or mission may generate measurement data collected by the sensors, such as bathymetry data, seabed imagery, water quality data and so on. Furthermore, the AUV may generate navigation and positioning data as well. The AUV also has to rely on communication data to operate, this may involve receiving commands and transmitting status updates and telemetry data to a remote control centre or a surface vessel. All the data may be specified respectively with different purposes.

The service of the present disclosure defines a collection of mapping policies or routing policies for specifying communication paths or routes to be used, between the offshore vehicle and the land operating centres, for data of different purposes. Different mapping/routing policies are designed for different operational modes of the offshore vehicle, each mapping/routing policy comprises a group of mapping rules each associating a purpose of data traffic with one or more communication paths and a priority level of the one or more communication paths.

The operational mode of the offshore vehicle may also be referred to as the asset mode, which is a defined operational state of the offshore vehicle, that is, in-transit, performing operations, down on weather, launching or recovering robots, etc.

Multiple asset modes may exist for a given project, and each asset mode will have a collection of mapping/routing policies associated with it. Whenever the offshore vehicle's mode changes from one asset mode to another, the current active mapping policies will be replaced with a collection of mapping policies associated with the new asset mode.

Mapping rules can be created via a User Interface application, API calls, or read from file storage.

The operational mode or asset mode of the offshore vehicle is determined based on information received from the offshore vehicle. As an example, information received from the offshore vehicle may comprise one or more of telemetry data, measurement data, a state report, an alarm message, data log, a control message.

A land-based operation centre can determine the operational status of an offshore vessel through various means and data sources. Monitoring the operational status of offshore vessels is crucial for safety, efficiency, and mission success. In the following some methods and data sources used to assess the operational status of offshore vessels are described.

As one example, offshore vessels or vehicles often have communication systems that allow them to transmit real-time telemetry data to the land-based operation centre. This data includes information on vessel position, speed, heading, engine status, power consumption, and more. It is possible that the operational mode of the vessels can be determined based on these data.

As another example, Automatic Identification System, AIS, transponders are provided for many offshore vessels, which would broadcast vessel information, including identification, position, speed, and course, to nearby vessels and shore-based AIS stations. Land-based operation centres can access this AIS data to track vessel movements and assess their status.

Other method of determining the operational mode of the offshore vehicle may relay on vessel monitoring systems, VMS, used for tracking and monitoring fishing vessels.

Moreover, satellite-based remote sensing and imaging technology can be used to monitor offshore vessels. Satellite imagery can provide visual data on vessel locations, activities, and even environmental conditions in the vicinity. Also, radar systems at coastal monitoring stations can track vessel movements in the nearshore and offshore areas, which can provide information on vessel positions, heading, and speed as well.

Besides, real-time weather and oceanographic data can be collected and analysed to assess the operational conditions that vessels are operating in. This includes information on sea state, wind speed, and other environmental factors that can impact vessel operations. This allows the operational mode of the offshore vehicle to be determined as well.

Offshore vessels may be equipped with various sensors and alarms that monitor critical systems and conditions. These include engine health, safety systems, environmental conditions, and equipment status. Alarms can trigger alerts to the operation centre if an issue is detected, allowing the operation centre to determine the operational mode of the offshore vessels.

Other means helping the land-based operation centre to determine the operational mode of the offshore vehicle include using specialized vessel tracking software and platforms to monitor the movements and status of offshore vessels and using publicly available marine traffic websites and services to track and monitor vessel movements. In-Person reports and communication may also be used, which involves direct communication with the vessel's crew or personnel via radio, satellite phone, or other means to obtain real-time information about the vessel's status, activities, and any issues or emergencies.

Electronic logbooks and reporting may also be used by the operation centre to determine the operational status of the offshore vehicle.

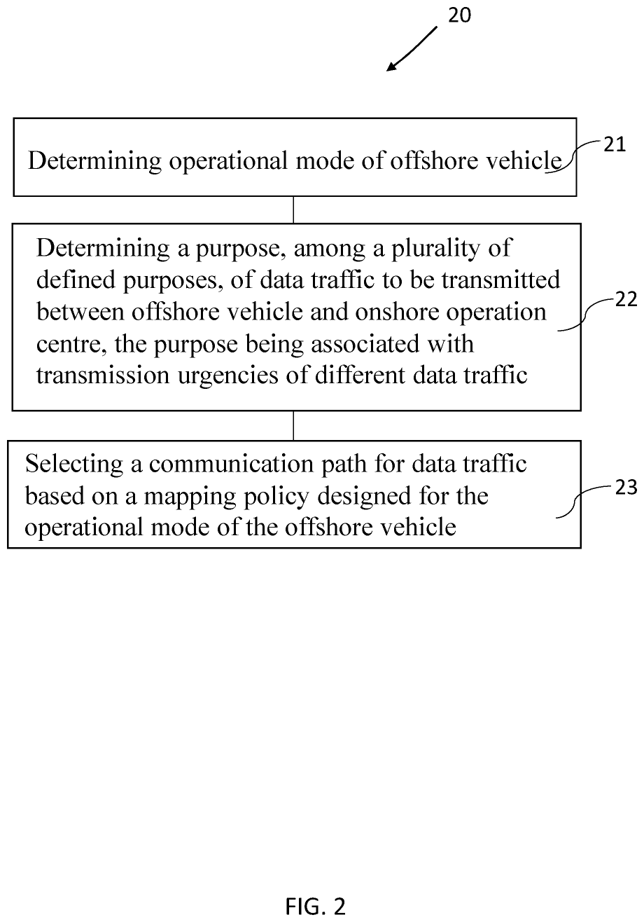

FIG. 2 schematically illustrates, in a flow chart type diagram, an embodiment of a method 20 for selecting a communication path to be used between an offshore vehicle and an onshore operation centre. In the embodiment, multiple communication paths employing different communication technologies are available between the offshore vehicle and the onshore operation centre.

In addition to the offshore vehicles or remote vessels and the land-based operation centres, the method of the present disclosure may involve the cloud. Communication can be directly between the offshore vehicle and the operation centre. As an alternative, the data can pass through a cloud instance of the service, in the case where the offshore vehicle cannot directly reach the operation centre, and/or in the case where multiple centres may need to communicate with the offshore vehicle.

Referring to FIG. 2, at step 21, the method of the present disclosure determines an operational mode of the offshore vehicle. The operational mode of the offshore vehicle may be determined based on one or more the above-described methods.

It is possible that the operational mode of the offshore vehicle remains the same as a previous time when the operational mode of the same offshore vehicle was determined. In this case, the mapping policy used for mapping different data being transmitted/to be transmitted between the offshore vehicle and the onshore operation centre may remain the same. On the other hand, depending on factors such as availability of the communication resources and variation of the volume of different data to be transferred between the offshore vehicle and the onshore operation centre, current communication paths being used for data transmission may also be changed or adapted.

When there is a change in the operational mode of the offshore vehicle, most likely the data to be transferred between the vehicle and the onshore operation centre will be different than with the previous operational mode.

In this case, at step 22, the method of the present disclosure determines a purpose, among a plurality of defined purposes, of data traffic to be transmitted between the offshore vehicle and the onshore operation centre. As described above, the purposes of different data are associated with different transmission urgencies. This is reflected in the mapping policy designed for the current operational mode of the offshore vehicle.

At step 23, based on the operational mode, and the determined purpose of the data, a communication path for transmitting the data is selected according to a mapping policy specially designed for the operational mode.

Based on the inventive idea of the present disclosure, all traffic will be categorized into a variety of “Purposes”, each of these Purposes can have their own route, or routes, defined, along with their own priority per route.

For example, mission critical data could be routed over multiple providers (VSAT and 4G) to an operation centre, while non-critical data could be sent over the cheapest provider at a lower priority. As will be understood by those skilled in the art, critical data as used here is refers to data whose transmission requires little or no latency. In this sense, the categorizing or purposes specified for different data is associated with transmission urgencies of different data.

More importantly, this mapping of Purposes to Routes & Priority can be defined dynamically, based on the state of operations or operational mode of the offshore vehicle. It is noted that the mapping may also be adjusted based decisions of the operating centre, which often are related to the operational modes of the offshore vehicle.

As an example, for an operational mode where the offshore vehicle is performing a task under control from the operation centre, the mapping policy may comprise the following rules:
1. Command & Control traffic is routed to an operation centre located in country A, over a 4G network and at Gold Priority, which represents the highest priority.
2. Navigation traffic is routed to a Cloud Hub located also in country A, over the 4G network, at Silver Priority.
3. Command & Control traffic is also routed to the Cloud Hub located in country A, over VSAT, at Silver Priority.
4. File Transfer traffic is routed to the operation centre in country A, over VSAT, at Bronze Priority.

This mapping policy allows command and control traffic to be routed or transmitted between the operation centre and the offshore vehicle with the least delay or latency. Moreover, redundancy is provided by making two communication paths available for the command and control traffic, that is, both to the operation centre and to the cloud hub. This ensures that the task is performed smoothly by the offshore vehicle.

Building on the previous example of mapping rules, during critical operations the mappings described above can be in place, but if the remote site is not performing critical operations, we can reduce the priority (and routes) of mission critical data, and increase the priority of other traffic (such as file transfers, software updates, backups, etc.)

In this sense, when the offshore vehicle is not performing its task due to for example bad weather conditions, a second and different mapping policy may be adopted for data transmission between the offshore vehicle and the operation centre. Based on this mapping policy, file transfer traffic may be given a higher priority and assigned with a communication path with higher transmission speed and shorter latency.

The uniqueness of this innovation lies in its ability to dynamically change both the routes and the priority of data as the state of operations of the offshore vehicle changes, providing the best connectivity option with redundancy and resiliency all in near real time while remotely operated.

The method of the present disclosure allows data to be routed from an offshore vehicle to an operation centre over one or more possible paths. These paths can be enabled simultaneously, meaning critical data can take multiple routes to the operation centre, ensuring the fastest data is used and that there is limited interruption of traffic if one path becomes unavailable.

The method also prioritizes the data on a route so that critical data is prioritized over less critical data. Last but not the least, the routing & prioritization are defined dynamically, meaning the priorities and routes can change based on user or external input.

The data may be routed based on known protocols which allows a group of data to be transmitted from a source to a specified destination, for example by routing traffic to a single, specific address, over a specific port, over a Wide Area Network, WAN. An example of such a protocol is the Data Distribution Service, DDS, protocol. Pre-existing data may be translated into the DDS protocol by converters. Alternatively, other protocols may also be used.

In the present disclosure, DDS is used as an exemplary protocol for routing categories of data to specific endpoints at specific priorities, while routing other data over (possibly) different routes and priorities.

The DDS protocol is a basic publish/subscribe layer on top of lower protocols, such as UDP, TCP, etc. The DDS middleware manages communication between the two entities. For implementing the method of the present disclosure, DDS middleware is configured on both the vessel and the land operation centre. This involves setting up the DDS infrastructure, including DDS Domain Participants, Topics, and Quality of Service, QoS, settings.

The DDS Domain is a logical separation within the DDS middleware that allows different applications or systems to operate independently. In a DDS deployment, the vessel and the land operation centre would be part of the same DDS domain to enable communication.

Each entity (vessel and land operation centre) involved in DDS communication create a DDS Domain Participant. The Domain Participant is an essential part of the DDS infrastructure, representing a participant in the DDS domain. It serves as the entry point for communication and discovery.

Topics define the types of data that can be communicated between DDS entities. In the context of the vessel and land operation centre, topics are related to the purposes of data as discussed above, which might be “Navigation Data”, “Diagnostic”, “Command & Control”, or “File Transfer”, and so on.

DDS Publishers are responsible for sending data, while DDS Subscribers are responsible for receiving data. Publishers and Subscribers are associated with specific topics or purposes as used in the present disclosure. In the case of the vessel, there would be a Publisher for sending data, and in the land operation centre, there would be a Subscriber for receiving that data, and vice versa for data sent from the land operation centre to the vessel.

DDS also allows various QoS settings to be configured such that specific requirements of the communication can be met. QoS settings include parameters related to reliability, durability, latency, and other aspects of communication. In this disclosure, it configure whether data should be reliably delivered, the maximum allowable latency, and how long historical data should be retained.

In the context of DDS, data under each topic or purpose is associated with DataWriters and DataReaders. DataWriters are responsible for writing data to the DDS middleware, and DataReaders are responsible for reading that data. in the present disclosure, both the vessel and the land operation centre have a corresponding DataWriter and DataReader for data of each purpose that they participate in.

DDS uses a discovery mechanism to enable entities to discover each other within the same DDS domain. This mechanism allows DataReaders to discover available DataWriters, that is, the vessel and the operation centre, and vice versa. This discovery process is necessary for establishing communication links dynamically.

The DDS configuration files is used to specify various settings discussed above, including domain configurations, QoS profiles, and other parameters. These configuration files help ensure consistency and ease of deployment.

DDS can operate over different transport layers, such as UDP/IP, TCP/IP, and others. Configuring the transport layer involves specifying the protocols and settings for data transmission. In the context of an offshore environment, considerations for satellite communication or other specific transport technologies like long-range wireless communication is relevant.

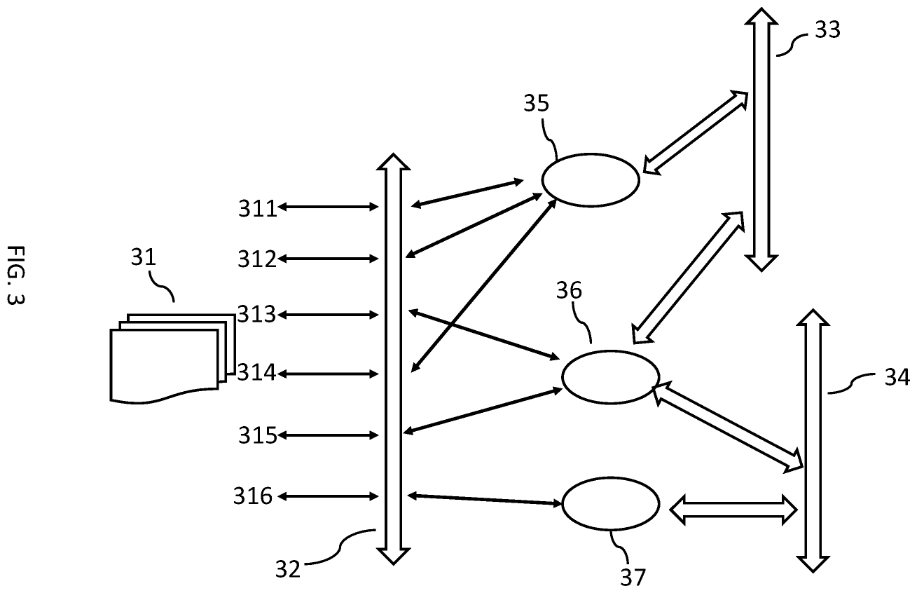

FIG. 3 schematically illustrate an example 30 of implementing the method of the present disclosure based on the DDS protocol. FIG. 3 illustrates routing data generated offshore for example on a vessel via a local DDS data bus respectively to DDS data buses configured for different transmission technologies.

In FIG. 3, data from and to applications 31 running on a computer device onboard a vessel a are grouped into different topics 311-316, and the topics are related to the purposes of data. In the example of FIG. 3, topics 311, 312 and 314 are related to purpose 1, which may be for example Navigation Data. Similarly, topics 313 and 315 are related to the same purpose 2, which can be for example Diagnostic data, while topic 316 is related to purpose 3, which is file transfer data.

By way of a local DDS data bus 32, data of topics 311 to 316 are respectively routed via different communication paths, via for example a DDS data bus 33 for the VSAT technology and or a DDS data bus for 4G 34. The routing is based on mapping policies described above, which designed for different operational modes of the offshore vehicle and each comprises a group of rules 35-37, each rule associating a purpose of data traffic with one or more communication paths and a priority level of the one or more communication path. The data from different applications is thereby communicated to land operation centres or the cloud deployed onshore.

As an example, rule 35 is applicable to date associated with purpose 1, allowing date categorized under purpose 1 to be routed via a route suitable for the current operational mode of the offshore vehicle. In FIG. 3 such data is illustrated as being routed using the VSAT technology.

The above describes applying different routing policies based on different operational modes of the offshore vehicle, when there are multiple communication paths employing different communication technologies are available between the offshore vehicle and the onshore operation centre. The method of the present disclosure can be extended to a more general scenario with one or more remote data infrastructure, including operation centres and cloud hubs located on the land.

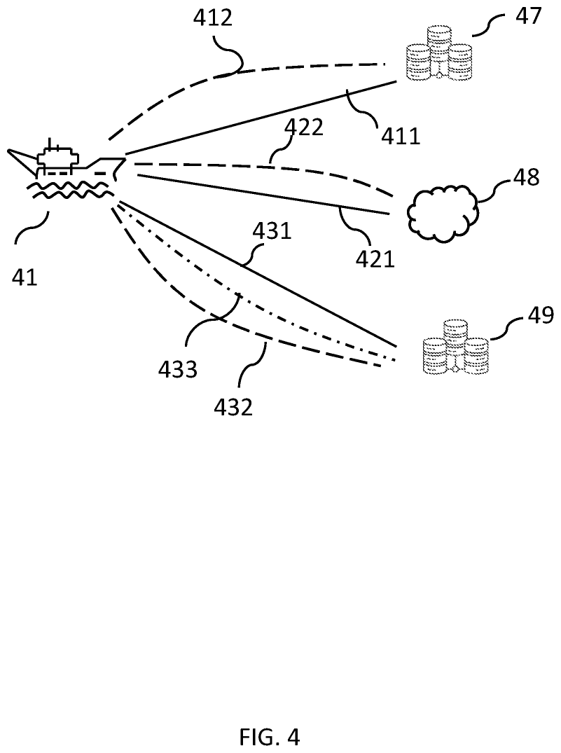

FIG. 4 schematically illustrates how the method of the present disclosure can be applied to different scenarios involving one or more remote data infrastructures communicating with the offshore vehicle based on a single or different communication technologies. In FIG. 4 only one offshore vehicle 41 is shown. It will be understood by those skilled in the art that any number of offshore vehicle located at different locations may communicate with the remote data infrastructures simultaneously.

### Example 1

Referring to FIG. 4, an offshore vehicle 41 is in communication with a land-based operation centre 47. In a relatively scenario, only one communication path or route 411 is available between the offshore vehicle 41 and the operation centre 47. The communication path 411 may use for example satellite communication.

In this case, a number of routing policies each corresponding to an operational mode of the offshore vehicle is defined. Each policy basically comprises a rule defining different priorities for data of different purposes. When the offshore vehicle switches from one operational mode to a different operational mode, a different routing policy will be adopted, allowing for example data of a purpose with a lower priority according to the previous routing policy to have a higher priority base don the current routing policy.

### Example 2

Still referring to FIG. 4, in this example, in addition to the land-based operation centre 47, the offshore vehicle 41 is in further communication with a cloud hub 48 via a communication path 421. The communication path 421 between the offshore vehicle 41 and the cloud hub 48 is based on the same communication technology as the communication path 411.

In this case, according to a routing policy designed for one of the operational modes of the offshore vehicle 41, data of a certain purpose, such as data requiring higher transmission reliability, may be routed to for example the operation centre 47 with a relatively higher priority via the communication path 411. In the meantime, this data may further be routed to the cloud hub 48 with a relatively lower priority via the communication path 421. Note that priority here is evaluated per communication link independently.

This would ensure that the data is reliably received on the land, as the data may be passed from the cloud hub 48 to the operation centre 47.

When the operational mode of the offshore vehicle 41 changes, data of another purpose may be allowed transmission redundancy, based on a routing policy designed for this new operational mode of the offshore vehicle 41. This allows flexibility in terms of allocation of the communication resources.

### Example 3

This example differs from Example 2 in that in addition to the communication path 411 and 421, a further communication path 412 (and 422) is available for one (or both) of the cloud hub 48 and the operation centre 47. The further communication paths 412 and 422 are based on a communication technology different than that used by the communication paths 411 and 412. For example, the further communication paths 412 and 422 can be based on cellular communication, which may include for example 4G or 5G communication.

In this example, when data of a certain purpose is routed to both the cloud hub 48 and the operation centre 47, the selected communication paths may use different communication technologies. This helps to further improve the transmission reliability.

### Example 4

This example shows a more complicated scenario involving two operation centres 47 and 48 and a cloud hub 48. In addition to the communication technologies, a third communication technology may be used to provide another communication route 433 between the offshore vehicle and the operation centre 49. It can be contemplated by those skilled in the art more flexible routing policies can be designed for different operational modes of the offshore vehicle 41, which allows even better best connectivity option with redundancy and resiliency.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method comprising:
determining an operational mode of an offshore vehicle;
determining a purpose, among a plurality of defined purposes, of data traffic to be transmitted between the offshore vehicle and an onshore data infrastructure, the purpose being associated with transmission urgencies of different data traffic; and
selecting a communication path of a plurality of communication paths for the data traffic based on a mapping policy designed for the operational mode of the offshore vehicle,
wherein different mapping policies are designed for different operational modes of the offshore vehicle, each mapping policy comprises a group of rules each associating a purpose of data traffic with one or more communication paths and a priority level of the one or more communication paths,
wherein the plurality of communication paths are configured to employ different communication technologies between the offshore vehicle and the onshore data infrastructure.

2. The method according to claim 1, wherein the operational mode of the offshore vehicle is determined based on information received from the offshore vehicle.

3. The method according to claim 2, wherein the information received from the offshore vehicle comprises one or more of telemetry data, measurement data, a state report, an alarm message, data log, a control message.

4. The method according to claim 1, wherein determining the operational mode of the offshore vehicle comprises determining that the operational mode of the offshore vehicle remains unchanged as or is different than a previously determined operational mode of a same offshore vehicle was determined.

5. The method according to claim 1, wherein the purpose of the data traffic is determined based on registration information, of an application supplying the data traffic, specified by a user.

6. The method according to claim 5, wherein multiple registration information is made by a single application.

7. The method according to claim 1, wherein the defined purposes comprise command and control, navigation, diagnostic data, and file transfer.

8. The method according to claim 1, wherein the selecting further comprising selecting more than one communication paths for the data traffic, the more than one communication paths are based on the different communication technologies and have different priority levels for the data traffic.

9. The method according to claim 1, wherein the mapping rules are amended per request by a user.

10. The method according to claim 1, wherein the communication technologies comprise satellite communication, Very Small Aperture Terminals, long-range wireless communication.

11. The method according to claim 10, wherein the long-range wireless communication comprises 4G and 5G wireless communication.

12. A device comprising:
a processor; and
a memory storing instructions, which when executed by the processor, causes the device to:
determine an operational mode of an offshore vehicle;
determine a purpose, among a plurality of defined purposes, of data traffic to be transmitted between the offshore vehicle and an onshore data center, the purpose being associated with transmission urgencies of different data traffic; and
select a communication path of a plurality of communication paths for the data traffic based on a mapping policy designed for the operational mode of the offshore vehicle,
wherein different mapping policies are designed for different operational modes of the offshore vehicle, each mapping policy comprises a group of rules each associating a purpose of data traffic with one or more communication paths and a priority level of the one or more communication paths, and
wherein the plurality of communication paths are configured to employ different communication technologies between the offshore vehicle and an onshore data infrastructure.

13. (canceled)

14. (canceled)

15. A method comprising:
determining an operational mode of a plurality of operational modes of an offshore vehicle;
determining a purpose, among a plurality of defined purposes, of a group of data traffic to be transmitted between the offshore vehicle and a remote data infrastructure, the purposes being associated with transmission urgencies of different data traffic;
selecting, based on the determined purpose, one or more mapping rules from a routing policy designed for the determined operational mode of the offshore vehicle; and
routing the group of data traffic between the offshore vehicle and the remote data infrastructure according to the one or more selected mapping rules,
wherein different routing policies are designed for the plurality of operational modes of the offshore vehicle, each routing policy comprises one or more mapping rules, each mapping rule associating a purpose of data traffic with one or more communication paths between the offshore vehicle and the remote data infrastructure and a priority level of the one or more communication paths.

16. The method according to claim 15, wherein the remote data infrastructure comprises a first entity having a first communication path to the offshore vehicle and a second entity having a second communication path to the offshore vehicle, the first and second communication paths based on a single communication technology,
wherein the selecting further comprising selecting more than one mapping rules designating more than one communication paths for the data traffic, the more than one communication paths having different priority levels for the data traffic.

17. The method according to claim 15, wherein the remote data infrastructure comprises a first entity each having a first communication path to the offshore vehicle and a second entity having a second communication path to the offshore vehicle, the first and second communication paths based on different communication technologies,
wherein the selecting further comprising more than one communication paths designating more than one communication paths for the data traffic, the more than one communication paths based on different communication technologies and having different priority levels for the data traffic.

18. The method according to claim 15, wherein the remote data infrastructure comprises an onshore operation center and a cloud hub.

19. The method according to claim 17, wherein the different communication technologies comprise satellite communication, Very Small Aperture Terminals, and long-range wireless communication.

20. A non-transitory computer readable storage medium storing instructions which, when executed on at least one processor, cause the at least one processor to:
determine an operational mode of an offshore vehicle;
determine a purpose, among a plurality of defined purposes, of data traffic to be transmitted between the offshore vehicle and an onshore data infrastructure, the purpose being associated with transmission urgencies of different data traffic;
select a communication path for the data traffic based on a mapping policy designed for the operational mode of the offshore vehicle,
wherein different mapping policies are designed for different operational modes of the offshore vehicle, each mapping policy comprises a group of rules each associating a purpose of data traffic with one or more communication paths and a priority level of the one or more communication paths.

21. The non-transitory computer readable storage medium according to claim 20, wherein the operational mode of the offshore vehicle is determined based on information received from the offshore vehicle.

22. The non-transitory computer readable storage medium according to claim 21, wherein the information received from the offshore vehicle comprises one or more of telemetry data, measurement data, a state report, an alarm message, data log, a control message.
